(19) United States
(12) Patent Application Publication
(10) Pub. No.: US 2024/0149471 A1
(43) Pub. Date: May 9, 2024

(54) Finger assembly and method

(71) Applicant: RightHand Robotics, Inc., Somerville, MA (US)

(72) Inventors: Timothy Fofonoff, Cambridge, MA (US); Nicholas Payton, Somerville, MA (US); Vivian Lee, Somerville, MA (US); Lael Odhner, Concord, MA (US)

(21) Appl. No.: 18/385,653

(22) Filed: Oct. 31, 2023

Related U.S. Application Data
(60) Provisional application No. 63/421,763, filed on Nov. 2, 2022.

(51) Int. Cl. B25J 15/12

(52) U.S. Cl. CPC B25J 15/12

(57) ABSTRACT

Finger assembly and method for performing a grasping operation. The finger assembly includes a base portion; a fingertip portion opposite the base portion; a front link portion operably connected to the base portion at a first location and operably connected to the fingertip portion at a second location, wherein the front link portion is compliant such that a distance between the first location and second location is variable during a grasping operation; and a rear link portion opposite the front link portion and operably connected to the base portion at a third location and operably connected to the fingertip portion at a fourth location.

### CROSS-REFERENCE TO RELATED APPLICATIONS

The present application claims the benefit of and priority to co-pending United States provisional application. no. 63/421,763, filed on Nov. 2, 2022, the entire disclosure of which is incorporated by reference as if set forth in its entirety herein.

### TECHNICAL FIELD

Embodiments described herein generally relate to robotic devices and methods and, more particularly but not exclusively, to robotic devices and methods for grasping items.

### BACKGROUND

Logistic operations such as those in warehouse environments often include robotic devices to gather items from a first location (e.g., a container) and place the items at a second location (e.g., on a conveyor belt). Accordingly, these operations require the robotic device to first grasp the item. Existing robotic devices often include one or more finger portions or a suction device that generates a suction force to “grasp” the item.

Existing picking devices are typically designed for a narrow range of items and those with similar features. For example, a picking device may have an end effector with one or more finger portions that are shaped, sized, and configured to grasp items of a particular size. Similarly, a picking device may be configured to only grasp items that have a particular shape, weight, material, surface, etc. This limits a picking device's utility, as it can only grasp items with certain characteristics. Additionally, these finger portions are typically rigid, which limits their ability to grasp a wider range of items and makes the finger portions susceptible to damage.

A need exists, therefore, for finger assemblies that overcome the disadvantages of existing configurations.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a finger assembly configured to perform a grasping operation. The finger assembly includes a base portion; a fingertip portion opposite the base portion; a front link portion operably connected to the base portion at a first location and operably connected to the fingertip portion at a second location, wherein the front link portion is compliant such that a distance between the first location and second location is variable during a grasping operation; and a rear link portion opposite the front link portion and operably connected to the base portion at a third location and operably connected to the fingertip portion at a fourth location.

In some embodiments, the front link portion is formed from a compliant material to buckle or compress during the grasping operation.

In some embodiments, the front link portion includes a pin, and at least one of the base portion and the fingertip portion include an aperture to receive the pin and enable movement of the pin, the base portion, or the fingertip portion during the grasping operation.

In some embodiments, the finger assembly further includes at least one spring device connected to the base portion and the fingertip portion to enable the front link portion to be compliant during the grasping operation. In some embodiments, the at least one spring device is a compression spring that connects the rear link portion and the fingertip portion at the fourth location.

In some embodiments, the front link portion includes a front stop portion, the rear link portion includes a rear stop portion, and the finger assembly further includes a spring device operably connected to the front stop portion and the rear stop portion.

In some embodiments, the base link is configured with a curved surface that is shaped to receive a portion of the front link, wherein the curved surface limits a bend radius of the front link. In some embodiments, the front link is operably connected to the base link via a pin at the first location, and the curved surface provides a non-linear hardening spring rate on the front link as the front link deflects during the grasping operation.

In some embodiments the front link is operably connected to the base link via a pin at the first location, and the curved surface provides a non-linear hardening spring rate on the front link as the front link deflects during the grasping operation.

In some embodiments, the front link is operably connected to the fingertip portion via a pin at the second location and the front link extends along a portion of the fingertip portion to provide a gripping surface to contact an item during the grasping operation.

In some embodiments, the front link portion includes a textured rubber portion to grip an item during the grasping operation.

In some embodiments, the rear link portion and the fingertip portion are fused together as a single component, the front link portion and the fingertip portion are fused together as a single component, or the base portion and the rear link portion are fused together as a single component.

According to another aspect, embodiments relate to a method for performing a grasping operation. The method includes actuating a finger assembly including a base portion; a fingertip portion opposite the base portion; a front link portion operably connected to the base portion at a first location and operably connected to the fingertip portion at a second location, wherein the front link portion is compliant such that a distance between the first location and second location is variable during a grasping operation; and a rear link portion opposite the front link portion and operably connected to the base portion at a third location and operably connected to the fingertip portion at a fourth location; and enabling, based on the actuation, at least one of the fingertip portion and the front link portion to contact an item.

In some embodiments, the method further includes enabling the front link portion to buckle or compress during contact with the item.

In some embodiments, the front link portion includes a pin, and at least one of the base portion and the fingertip portion include an aperture to receive the pin and enable movement of the pin, the base portion, or the fingertip portion during contact with the item.

In some embodiments, the finger assembly further includes at least one spring device connected to a portion of the rear link portion and the fingertip portion to enable the front link portion to be compliant during contact with the item.

In some embodiments, the at least one spring device is a compression spring that connects the rear link portion and the fingertip portion at the fourth location. In some embodiments, the front link portion includes a front stop portion, the rear link portion includes a rear stop portion, and the finger assembly further includes a spring device operably connected to the front stop portion and the rear stop portion.

In some embodiments, the base link is configured with a curved surface that is shaped to receive a portion of the front link, wherein the curved surface limits a bend radius of the front link. In some embodiments, the front link is operably connected to the base link via a pin at the first location, and the curved surface provides a non-linear hardening spring rate on the front link as the front link deflects during contact with the item.

In some embodiments, the front link is operably connected to the fingertip portion via a pin at the second location and the front link extends along a portion of the fingertip portion to provide a gripping surface to contact an item during the grasping operation.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates a robotic device performing a grasping operation in a warehouse environment in accordance with one embodiment;

FIGS. 2A-2D illustrate a finger assembly in accordance with one embodiment;

FIG. 3 illustrates a finger assembly in accordance with another embodiment;

FIG. 4 illustrates a finger assembly in accordance with another embodiment;

FIG. 5 illustrates a finger assembly in accordance with another embodiment;

FIG. 6 illustrates a finger assembly in accordance with another embodiment;

FIG. 7 illustrates a finger assembly in accordance with another embodiment;

FIG. 8 illustrates a diagram of a finger assembly in accordance with one embodiment; and

FIG. 9 depicts a flowchart of a method for performing a grasping operation in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

In the context of the present application, the term “first location” may refer to a location at which a front link portion connects with a base portion while the associated finger assembly is at rest or otherwise in an unloaded configuration (e.g., not performing a grasping operation). The term “second location” may refer to a location at which a front link portion connects with a fingertip portion while the associated finger assembly is at rest or otherwise in an unloaded configuration. The term “third location” may refer to a location at which a rear link portion connects with a base portion while the associated finger assembly is at rest or otherwise in an unloaded configuration. The term “fourth location” may refer to a location at which a rear link portion connects with a fingertip portion while the associated finger assembly is at rest or otherwise in an unloaded configuration.

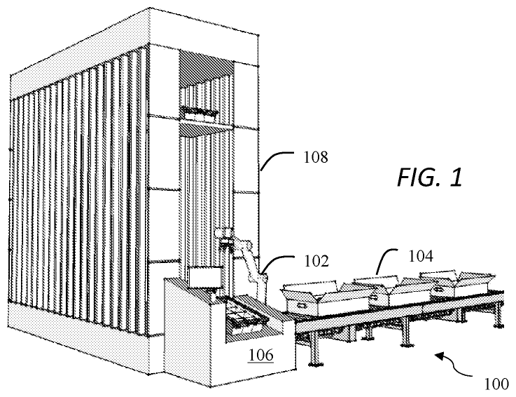

The embodiments described herein may be implemented in a variety of applications. For example, FIG. 1 illustrates an exemplary application in a warehouse environment 100 in which a gripping device 102 may be tasked with picking items from one or more containers 104, and placing the items at a loading station 106. These items may then be placed in a shipping container 108 for further shipment, sorting, processing, or the like

As discussed previously, existing devices for performing grasping operations on items suffer from various drawbacks. These drawbacks may relate to being unable to achieve a proper grip on an item or damaging the item.

The embodiments herein provide novel finger assemblies for performing grasping operations. These grasping operations may involve operations such as those in logistic operations in which a robotic manipulator is tasked with grasping an item from a first location, moving the item to a second location, and releasing the item at the second location.

For example, in some applications such as those in logistics, a robotic manipulator may be configured as part of a mobile robot that is tasked with gathering items from various locations throughout a warehouse. Once the manipulator grasps or otherwise obtains the item, the mobile robot may travel to and release the item at a second location in the warehouse such as a container or conveyor belt for further processing, shipment, or the like.

Similarly, in other applications, a robotic manipulator may be configured as part of mobile robot that is tasked with grasping items from a shipping container or conveyor belt. The mobile robot may then be tasked with traveling to a second location in a warehouse environment, such as a certain bin on a shelving unit. Upon reaching the second location, the robotic manipulator may place or otherwise release the item into the bin.

To obtain a grasp on an item such that the manipulator can process an item as required, robotic manipulators may be configured with one or more finger assemblies. These finger assemblies may include one or more motors or the like to drive one or more finger drive trains. The drive train(s) may include a series of gears to transmit torque from the servo motor(s) to select finger assemblies or components thereof. There are many variations on motor and gear designs that could result in higher or lower torques, smaller size, faster finger portion actuation, or other desirable properties. The exact size or configuration of these components may vary as long as the features of the embodiments described herein may be accomplished.

The embodiments herein provide improved finger assemblies for robotic manipulators. The finger assemblies described herein generally include a base link, a front link, a rear link, and a fingertip link. These links may be operably connected to each other via some combination of springs, elastic members, stop portions, pins, slots, cams, flexible joints, etc. The arrangement of these components provides novel finger assemblies with improved grasping capabilities and resiliency.

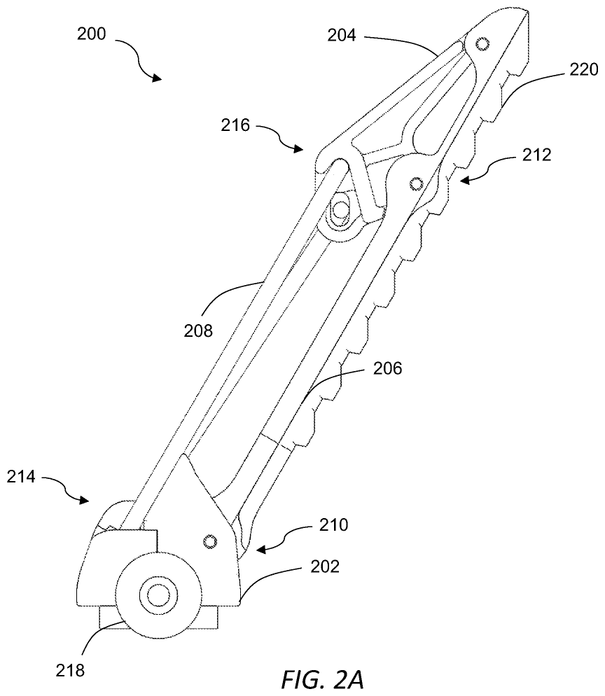

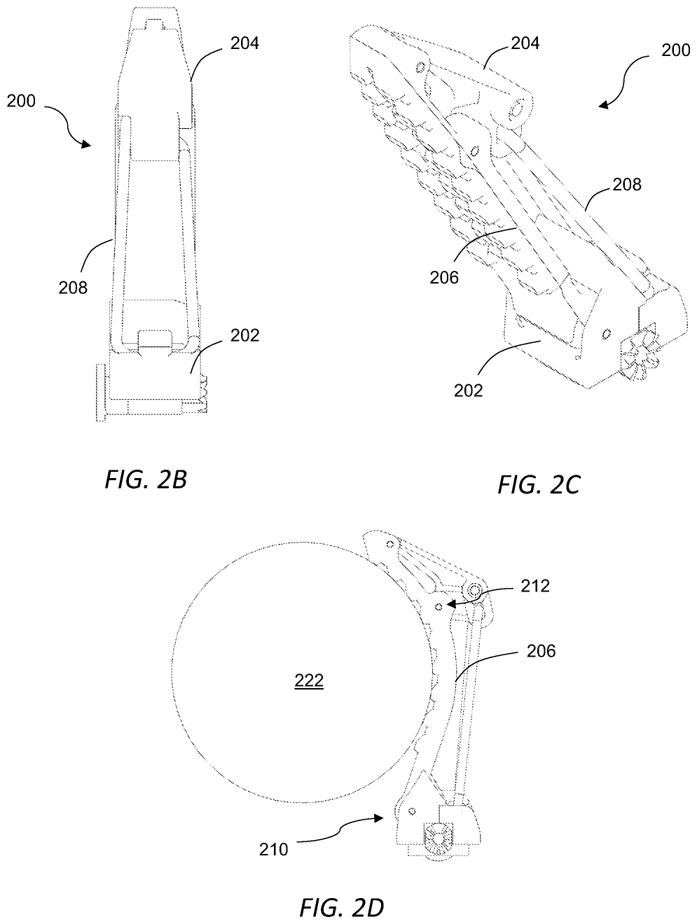

FIGS. 2A-2D illustrate a finger assembly 200 in accordance with one embodiment. The finger assembly 200 includes a base portion 202 and a fingertip portion 204 opposite the base portion 202. The finger assembly 200 may also include a front link portion 206 and a rear link portion 208.

The front link portion 206 may be operably connected to the base portion 202 at a first location 210 and operably connected to the fingertip portion 204 at a second location 212. The rear link portion 208 may be operably connected to the base portion 202 at a third location 214, and operably connected to the fingertip portion 204 at a fourth location 216. FIG. 2B illustrates a back view of the finger assembly 200 in accordance with one embodiment; FIG. 2C, a perspective view; and FIG. 2D, a view of the assembly 200 in a deformed or buckled state during a grasping operation.

One or more finger assemblies such as the finger assembly 200 may be connected to an end of a robotic arm (not shown in FIGS. 2A-2D). The robotic arm may position the one or more finger assemblies in proximity to an item to be grasped as part of a grasping operation. Once in sufficient proximity to a desired item, a control system (not shown in FIGS. 2A-D) may activate the robotic arm, one or more finger assemblies 200, or both, to grasp the item as part of the grasping operation.

The base portion 202, as well one or more of the fingertip portion 204, the front link portion 206, and rear link portion 208, may be formed from an elastomer material such as urethane, polyurethane, rubber, thermoplastic elastomers, or the like. The base portion 202 may further include an axle component 218 to connect to robotic manipulator. For example, the finger assembly 200 may rotate about an axis through the axle component 218 as part of a grasping operation.

The front link portion 206 may extend along a portion of the fingertip portion 204 and may include a material 220 such as a textured material to facilitate the grasping of an item during a grasping operation. In some embodiments, the material 220 may be a high-friction material that contacts an item during a grasping operation.

In some embodiments, the fingertip portion 204 or the material 220 may be modular such that it can be substituted with a different material. For example, a high friction surface may be removed from the fingertip portion 204, front link portion 206, or both, and replaced with a low friction surface to accommodate a different type of item or goal of an operation. In some embodiments, a finger assembly may be constructed such that a portion of the fingertip portion contacts an item.

In some embodiments, the front link portion 206 may be compliant. For example, the front link portion 206 may be formed from or include a compliant material. As seen in FIG. 2D, this allows the front link portion 206 to curl, compress, buckle, or otherwise deform while grasping an item 222 during a grasping operation. This deformation of the front link portion 206 causes the distance between the first location 210 and the second location 212 to change or otherwise be variable during the grasping operation. This allows the front link portion 206 to add compliance to the finger assembly 200, and allows the front link portion 206 to absorb impacts without risking damage to the finger assembly 200. Once the item is removed, such as upon the completion of a grasping operation, the front link portion 206 and the finger assembly 200 may return it a neutral position

Using a compliant material in conjunction with the front link portion is 206 is one of several techniques for achieving compliance in the finger assembly. For example, in addition to or in lieu of using a compliant material for or with the front link portion, the embodiments described herein may use compliant connection means at the first location, the second location, or both, as discussed below.

In some embodiments, the rear link portion 208 may be configured as a carabiner gate spring. This may be one possible implementation of a cammed spring that combines a spring function at the third location 214. One or more portions of the rear link portion 208 may be bent and inserted through the fingertip portion 204.

In some embodiments, a stiff spring may be attached to a link portion to apply torque to another link portion. For example, the spring may apply torque to another link portion via a cammed surface. This allows the use of stiffer springs such as leaf springs, and also opens up the possibility of the spring being part of the link portion. In these embodiments, the cam surface may be placed in various positions around a pivot location and could be a curved surface to produce non-linear spring forces.

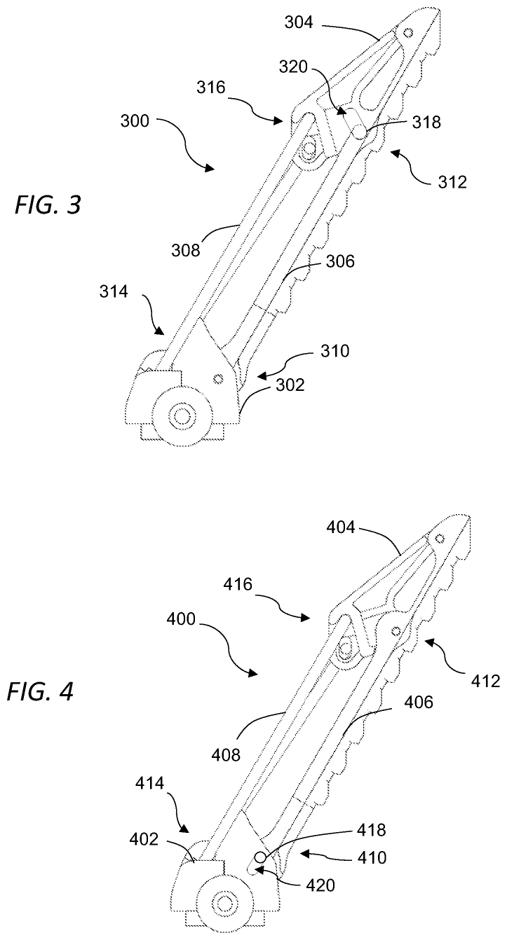

FIG. 3 illustrates a finger assembly 300 in accordance with another embodiment. The finger assembly 300 may be configured similarly to the finger assembly 200 of FIG. 2 and include a base portion 302, fingertip portion 304, front link portion 306, and rear link portion 308. The front link portion 306 may be operably connected with the base portion 302 at a first location 310, and operably connected with the fingertip portion 304 at a second location 312. The rear link portion 308 may be operably connected with the base portion 302 at a third location 314, and operably connected with the fingertip portion 304 at a fourth location 316.

In the embodiment of FIG. 3, the front link portion 306 includes a pin 318 that engages an aperture 320 or slot in the fingertip portion 304. The placement of the front link portion 306 with respect to aperture 320 allows the finger assembly 300 to be compliant under loading. For example, upon loading the front link portion 306 and the fingertip portion 304 may move with respect to each other such that the location of the pin 318 with respect to the aperture 320 can vary. This causes the distance between the first location 310 and the second location 312 to change or otherwise be variable during the grasping operation.

FIG. 4 illustrates a finger assembly 400 in accordance with another embodiment. The finger assembly 400 may be configured similarly to the finger assembly 300 of FIG. 3 and include a base portion 402, fingertip portion 404, front link portion 406, and a rear link portion 408. The front link portion 406 is operably connected with the base portion 402 at a first location 410, and operably connected with the fingertip portion 404 at a second location 412. The rear link 408 is operably connected with the base portion 402 at a third location 414, and operably connected with the fingertip portion 404 at a fourth location 416.

In the embodiment of FIG. 4, the front link portion 406 includes a pin 418 that engages an aperture 420 in the base portion 402. The placement of the front link portion 406 with respect to aperture 418 allows the finger assembly 400 to be compliant under loading. For example, upon loading the front link portion 406 and the base portion 402 may move with respect to each other. This causes the distance between the first location 410 and the second location 412 to change or otherwise be variable during the grasping operation.

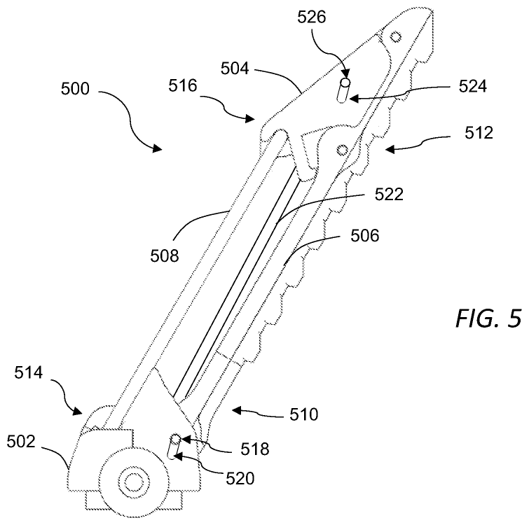

FIG. 5 illustrates a finger assembly 500 in accordance with another embodiment. The finger assembly 500 may be configured similarly to the finger assembly 300 of FIG. 3 and include a base portion 502, fingertip portion 504, front link portion 506, and a rear link portion 508. The front link portion 506 is operably connected with the base portion 502 at a first location 510, and operably connected with the fingertip portion 504 at a second location 512. The rear link portion 508 is operably connected with the base portion 502 at a third location 514, and operably connected with the fingertip portion 504 at a fourth location 516.

In this embodiment, the front link portion 506 is configured as or with a pin 518 that engages an aperture 520 in the base portion 502. The placement of the front link portion 506 with respect to the aperture 520 allows the finger assembly 500 to be compliant under loading. For example, upon loading the front link portion 506 and the base portion 502 may move with respect to each other such that the distance between the second location 512 and the first location 510 can vary.

The finger assembly 500 of FIG. 5 may also include a middle link portion 522 that extends from the base portion 502 to the fingertip portion 504. For example, and as seen in FIG. 5, the fingertip portion 508 may include a second aperture 524 or slot that receives a pin 526 associated with the middle link portion 522. The middle link portion 522, by virtue of its configuration and position with respect to the second aperture 524, may provide a biasing force to deflect the fingertip portion 504 to its neutral position upon removal of a loading force.

For example, in operation, the first link portion 506 may compress or otherwise buckle as the finger assembly 500 grasps an item during a grasping operation. This compression or buckling may cause the distance between the first location 510 and the second location 512 to change.

Once the item is released or otherwise separated from the finger assembly 500, the middle link portion 522 may push the fingertip portion 504 back toward its original position. For example, the middle link portion 522, if configured as a compression spring, would naturally return the finger assembly 500 to its original or otherwise unloaded state.

The embodiments herein may include one or more springs and in a variety of configurations and locations. For example, the finger assemblies described herein may include one or more of coil springs, flexure springs, cross-link springs, compression springs, cross-link tension springs, or some combination thereof. These springs may connect or otherwise be positioned between two portions of a finger assembly. For example, to enable a front link portion of a finger assembly to be compliant, the finger assembly may include a spring attached to the rear link portion and the fingertip portion. Other spring locations, along with the use of different spring types, may impart different types of compliance on a finger assembly.

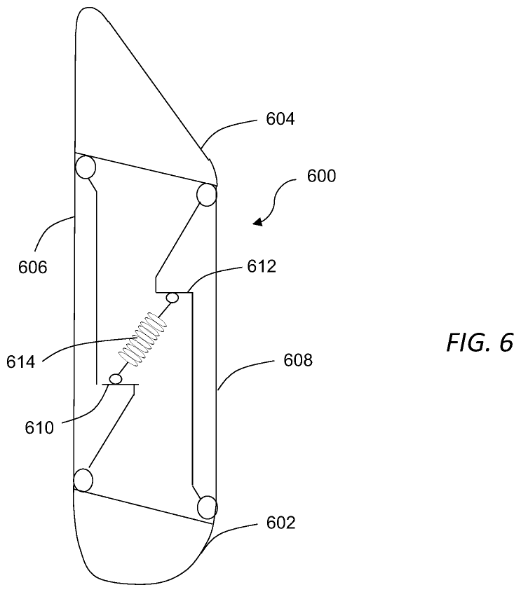

FIG. 6 illustrates a finger assembly 600 in accordance with another embodiment. As in previous embodiments, the finger assembly 600 may include a base portion 602, fingertip portion 604, front link portion 606, and rear link portion 608. The front link portion 606 may be compliant using one or more of the techniques discussed previously.

The front link portion 606 and the rear link portion 608 may include stop portions 610 and 612, respectively. A spring 614 such as a tension spring may connect the stop portions 610 and 612 to, for example, limit the range of motion of various components of the finger assembly 600. In some embodiments, a spring may not be needed, and a finger assembly may include stop portions that are positioned and sized to contact each other to limit the amount of defection of one or more components of a finger assembly.

The previous discussions and related figures are largely directed toward different configurations of the front link portions. In embodiments using these front link portions or other types of compliant front link portions, there may be a variety of ways to attach or otherwise operably connect a front link portion to a base portion.

In some embodiments, the front link portion may be formed from a compliant material and may be directly attached to the base portion. For example, the compliant material may be attached to a rear link portion via an adhesive. This configuration allows the front link portion to bend at the location between the base portion and the front link portion to provide a front proximal pivot.

In some embodiments, such as those with a compliant material as a front link portion or rear link portion, the base portion may include a curved surface and slot to receive the front link portion. The curved surface limits the bend radius of the front link portion, allows for the user of stiffer material(s) for the front link portion, and provides more control over the instantaneous center of joint movement.

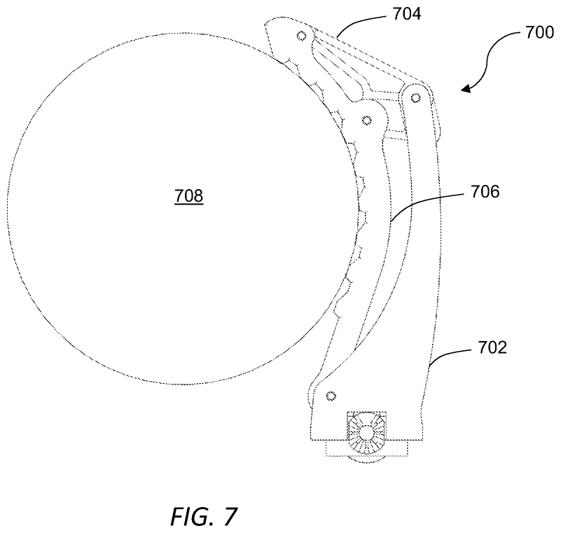

FIG. 7 illustrates a finger assembly 700 in accordance with another embodiment. The finger assembly 700 may include a base portion 702, a fingertip portion 704, and a front link portion 706. That is, the finger assembly 700 does not have a separate, individual “rear link” component. Rather, the base portion 702 extends up toward and in operable connectivity with the fingertip portion 704. In this embodiment, the base portion 702 may be referred to as a fused portion, such as if a rear link portion and base portion were fused together.

As in previous embodiments, the front link portion 706 is formed from or otherwise includes a compliant material that may flex or deform. In this embodiment, the fingertip portion may be sprung or preloaded so that the front link portion 706 is either under tension (such as with a spring, not shown), or held in place if there is a stop portion.

As seen in FIG. 7, when an item 708 is pressed against the front link portion 706, the spring preload may supply tension to the front link portion 706 to help with gripping. In some embodiments, the fingertip portion 704 and the base portion 702 may be merged or fused into a single component. In these embodiments, deflection in the front link portion 706 would be solely by stretching, with no geometry change or preload added by other components.

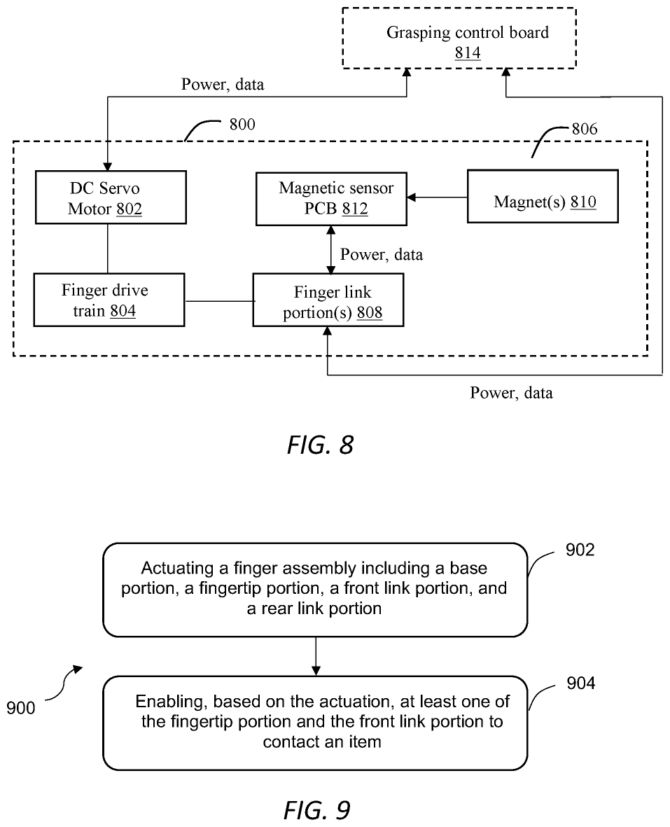

FIG. 8 depicts an exemplary architecture of the finger portion assembly 800 in accordance with one embodiment. The finger portion assembly 800 may include one or more servo motors 802 configured to drive one or more finger drive trains 804. The servo motor(s) 802 may be off-the-shelf motors with a machined frame, for example. The drive train 804 may include a series of gears to transmit torque from the servo motor(s) 802 to the rotational axis of the finger portion(s) of one or more finger assemblies 806. There are many variations on motor and gear designs that could result in higher or lower torques, smaller size, faster finger portion actuation, or other desirable properties. Accordingly, the amount of finger portion deflection may be determined by monitoring torque as well. The exact size or configuration of these components may vary as long as the features of the embodiments described herein may be accomplished.

The one or more finger assemblies 806 may receive power from the drive train 804 at a finger link portion (e.g., a base portion, fingertip portion, front link portion, rear link portion, or some combination thereof). The finger portions may be formed from solid polyurethane rubber molded to form a plurality of link portions as discussed previously. The finger link portions 808 may include wires that pass through a gasket into the center of an axle therein.

In other embodiments, a pneumatic actuator may close or open the finger assembly(ies) with a return spring to provide motion in the opposite direction. Similarly, a dual-acting pneumatic actuator could be used to drive the finger portion(s) in both directions.

In some embodiments, a finger assembly may include magnets 810 embedded in link portions that correspond to Hall effect sensors molded on a magnetic sensor printed circuit board (PCB) 812. In this configuration, deflection of the link portions of finger assembly(ies) cause the magnets 810 to shift relative to the magnetic sensor PCB 812. The resultant signal(s) may help determine how much deflection the associated finger portion is experiencing. Additionally, these signal(s) may provide data regarding the direction of the load.

As seen in FIG. 8, data regarding the finger portion(s)′ operation may be communicated to a grasping control board 814. For example, data regarding the position of the finger portion(s) may be monitored via an encoder (not shown in FIG. 8) linked directly to one or more finger portions. Or, an encoder may similarly be connected to the motor 802.

If pneumatic actuation is used to actuate the finger portion(s), force on the finger portion(s) may be measured by monitoring pressure. If electric actuation is used, force on the finger portion can be measured by monitoring current. Force on the finger portion(s) (which may be indicative of whether an item is being grasped), can be more precisely determined by measuring the deflection of a series spring or load cell. As the finger portions are compliant, force can be monitored by measuring the deflection of the finger portions themselves.

Feedback about the item and quality of the grasp can be obtained via tactile sensing. Sensors placed in the finger portions themselves can be used to detect whether an item has been contacted, how much pressure is applied to the item, and where on the finger portion the item is contacting. For example, a MEMS barometer may be embedded in a molded rubber core 808 of a finger portion to detect and measure surface pressure. The above-described techniques of measuring or otherwise monitoring deflection of the finger portion(s) are merely exemplary and other techniques, whether available now or invented hereafter, may be used.

FIG. 9 depicts a flowchart of a method 900 for performing a grasping operation in accordance with one embodiment. Method 900 may involve any of the finger assemblies discussed previously.

Step 902 involves actuating a finger assembly. The finger assembly includes a base portion; a fingertip portion opposite the base portion; a front link portion operably connected to the base portion at a first location and operably connected to the fingertip portion at a second location, wherein the front link portion is compliant such that a distance between the first location and second location is variable during a grasping operation; and a rear link portion opposite the front link portion and operably connected to the base portion at a third location and operably connected to the fingertip portion at a fourth location.

Step 904 involves enabling, based on the actuation, at least one of the fingertip portion and the front link portion to contact an item. That is, as the result of the actuation, the fingertip portion may contact the item, the front link may contact the item, or the fingertip portion and the front link portion may contact the item.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A finger assembly configured to perform a grasping operation, the finger assembly comprising:
a base portion;
a fingertip portion opposite the base portion;
a front link portion operably connected to the base portion at a first location and operably connected to the fingertip portion at a second location, wherein the front link portion is compliant such that a distance between the first location and second location is variable during a grasping operation; and
a rear link portion opposite the front link portion and operably connected to the base portion at a third location and operably connected to the fingertip portion at a fourth location.

2. The finger assembly of claim 1 wherein the front link portion is formed from a compliant material to buckle or compress during the grasping operation.

3. The finger assembly of claim 1 wherein the front link portion includes a pin, and at least one of the base portion and the fingertip portion include an aperture to receive the pin and enable movement of the pin, the base portion, or the fingertip portion during the grasping operation.

4. The finger assembly of claim 1 further comprising at least one spring device connected to the base portion and the fingertip portion to enable the front link portion to be compliant during the grasping operation.

5. The finger assembly of claim 4 wherein the at least one spring device is a compression spring that connects the base portion and the fingertip portion at the fourth location.

6. The finger assembly of claim 1 wherein:
the front link portion includes a front stop portion,
the rear link portion includes a rear stop portion, and the finger assembly further includes a spring device operably connected to the front stop portion and the rear stop portion.

7. The finger assembly of claim 1 wherein the base link is configured with a curved surface that is shaped to receive a portion of the front link, wherein the curved surface limits a bend radius of the front link.

8. The finger assembly of claim 7 wherein the front link is operably connected to the base link via a pin at the first location, and the curved surface provides a non-linear hardening spring rate on the front link as the front link deflects during the grasping operation.

9. The finger assembly of claim 1 wherein the front link is operably connected to the fingertip portion via a pin at the second location and the front link extends along a portion of the fingertip portion to provide a gripping surface to contact an item during the grasping operation.

10. The finger assembly of claim 1 wherein the front link portion includes a textured rubber portion to grip an item during the grasping operation.

11. The finger assembly of claim 1 wherein the rear link portion and the fingertip portion are fused together as a single component, the front link portion and the fingertip portion are fused together as a single component, or the base portion and the rear link portion are fused together as a single component.

12. A method for performing a grasping operation, the method comprising:
actuating a finger assembly including:
a base portion;
a fingertip portion opposite the base portion;
a front link portion operably connected to the base portion at a first location and operably connected to the fingertip portion at a second location, wherein the front link portion is compliant such that a distance between the first location and second location is variable during a grasping operation; and
a rear link portion opposite the front link portion and operably connected to the base portion at a third location and operably connected to the fingertip portion at a fourth location; and
enabling, based on the actuation, at least one of the fingertip portion and the front link portion to contact an item.

13. The method of claim 12 further comprising enabling the front link portion to buckle or compress during contact with the item.

14. The method of claim 12 wherein the front link portion includes a pin, and at least one of the base portion and the fingertip portion include an aperture to receive the pin and enable movement of the pin, the base portion, or the fingertip portion during contact with the item.

15. The method of claim 12 wherein the finger assembly further includes at least one spring device connected to a portion of the rear link portion and the fingertip portion to enable the front link portion to be compliant during contact with the item.

16. The method of claim 12 wherein the at least one spring device is a compression spring that connects the rear link portion and the fingertip portion at the fourth location.

17. The method of claim 16 wherein the front link portion includes a front stop portion, the rear link portion includes a rear stop portion, and the finger assembly further includes a spring device operably connected to the front stop portion and the rear stop portion.

18. The method of claim 12 wherein the base link is configured with a curved surface that is shaped to receive a portion of the front link, wherein the curved surface limits a bend radius of the front link.

19. The method of claim 18 wherein the front link is operably connected to the base link via a pin at the first location, and the curved surface provides a non-linear hardening spring rate on the front link as the front link deflects during contact with the item.

20. The method of claim 12 wherein the front link is operably connected to the fingertip portion via a pin at the second location and the front link extends along a portion of the fingertip portion to provide a gripping surface to contact an item during the grasping operation.
